(19) United States
(12) Patent Application Publication
(10) Pub. No.: US 2004/0127273 A1
(43) Pub. Date: Jul. 1, 2004

(54) Interactive game

(76) Inventors: Aaron J. Englert, Los Angeles, CA (US); Anthony D. Bamonte, Los Angeles, CA (US); Thomas L. Schleuning, Beverly Hills, CA (US)

Correspondence Address: Thomas R. Juettner, Greer, Burns & Crain. Ltd., Suite 2500, 300 South Wacker Drive, Chicago, IL, 60606, US

(21) Appl. No.: 10/737,638

(22) Filed: Dec. 15, 2003

Related U.S. Application Data
(60) Provisional application No. 60/433,867, filed on Dec. 17, 2002.

(51) Int. Cl. A63F 9/24; A63F 13/00

(52) U.S. Cl. 463/7

(57) ABSTRACT

An interactive game for a number of players employs a device that is passed from player to player and contains a speaker and/or visual display, a memory coupled to the speaker and/or display containing stored inquiries or directions, and a switch for activating the memory and causing an inquiry or direction to be communicated to a player via the speaker and/or display. After a first recipient player has responded to an inquiry or direction, the device is again passed from player to player to cause another inquiry or direction to be communicated to a second recipient for response. Scores of the responses of the players may be kept. The inquiries or directions may be related to any subject category or topic, such as social, political and/or educational topics.

### CROSS REFERENCE

This application is a continuation of co-pending application Ser. No. 60/433,867 filed Dec. 17, 2002.

### FIELD OF THE INVENTION

The invention relates to games intended for play by a number of people, such as parlor games, social games, educational games, school games and the like, and particularly to an interactive game employing a device to be repeatedly passed from player to player and that communicates to each recipient player one of a variety of inquiries, questions and/or directions to be responded to by the recipient player.

### BACKGROUND

Parlor and social games for play by a number of people are quite popular and serve as a source of fun and a social catalyst or “ice breaker”. Educational games for play by a number of students are also popular and make learning a more enjoyable and fun experience.

The object of the present invention is to provide a new and more interesting game utilizing an interactive electronic device containing a memory that communicates questions and/or directions for response by the participants.

### SUMMARY OF THE INVENTION

The invention provides a device, preferably a hand held device such as a ball, adapted to be passed among a number of players. The device contains a power source, a speaker and/or a visual display, a memory, such as a disk or microchip, coupled to the speaker and/or visual display and containing in memory a variety of inquiries and/or directions to be communicated to the players, particularly a recipient player to whom the device has been passed, and a switch or like means for activating the memory and causing an inquiry or direction to be communicated via the speaker and/or visual display to a recipient player. After the recipient player responds to the inquiry or direction, the device is again passed around to pose a different inquiry or direction to a second recipient player, and so on.

The memory may be pre-programmed or programmable to any of a wide variety of subject categories such as sports, politics, religion, social issues, education, history, geography, mathematics, sciences, world affairs, morals, ethics and trivia. The memory may also be programmed to provide answers to questions where appropriate. Scores of the participants' responses may if desired be kept to determine a winner in a selected category.

The device thus provides an entertaining and/or educational game for play by groups of adults, adolescents or children in various social and/or educational environments.

These and other objects and advantages of the invention will become apparent to those of reasonable skill in the art from the following detailed description, as considered in conjunction with the accompanying drawings.

### BRIEF DESCRIPTION OF THE DRAWINGS

FIG. 1 is a perspective view of an embodiment of the device of the invention in the form of an essentially spherical ball;

FIG. 2 is a cross-sectional view of a ball illustrating schematically the electrical and/or electronic components contained within the ball; and

FIG. 3 is an elevational view of a combination display and battery-charging stand for the ball.

### DETAILED DESCRIPTION OF PREFERRED EMBODIMENTS

The following is a detailed description of certain embodiments of the invention presently deemed by the inventors to be the best mode of carrying out their invention.

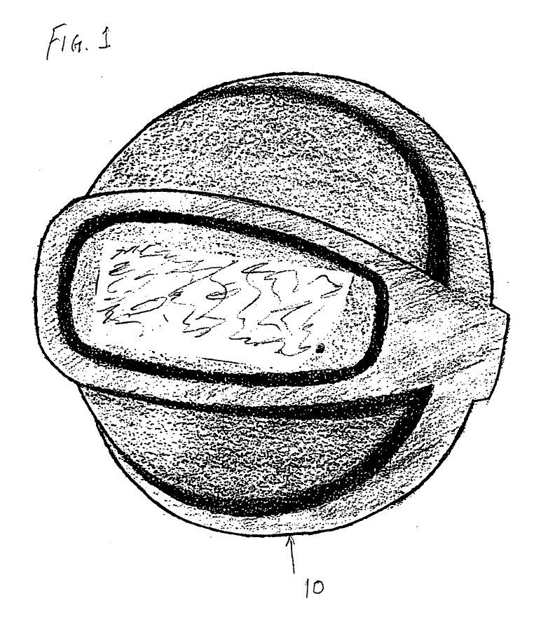

Referring to FIG. 1, the device 10 of the invention may conveniently take the form of a ball, for example, a ball of distinctive design as illustrated in FIG. 1, or a spherical ball such as used to play baseball, basketball or soccer, or an ellipsoid ball such as used to play football or rugby. Alternatively, the device may take any shape appropriate to the purposes of the game to be played, for example, a book, map or globe. Irrespective of the specific shape, it is preferable that the physical device 10 be of such size, shape and weight that it can be conveniently and safely passed, tossed or thrown from player to player in a residential or classroom setting.

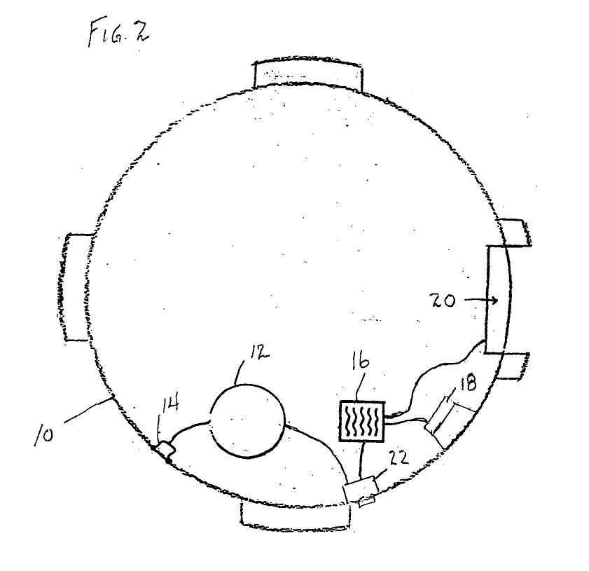

Within its interior, as illustrated schematically in FIG. 2, the device 10 houses a rechargeable power supply or battery 12, a charger port or connector 14 for use in recharging the battery, a memory unit, disk or chip 16 electrically connected to the battery 12, an audio speaker 18 connected to the battery 12 and memory 16, and a visual or video display unit 20 such as a LCD device also connected to the battery 12 and memory 16. A switch 22 controls activation of the illustrated circuitry. The switch may be manually operable or may be an inertia or impact responsive switch activated by the act of passing or receiving the device 10.

Preferably, the device 10 also includes on its exterior surface one or more or a string of lights (not shown) adapted to be energized in a continuous on, flashing, or traveling or chasing mode to signal different stages in the play of the game.

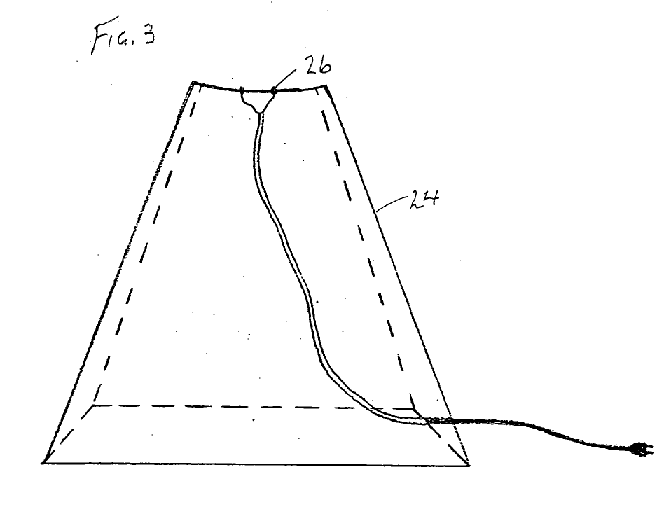

When not in active use for playing a game, the device may be stored on a display stand 24, as illustrated in FIG. 3. Preferably, the display stand includes a battery charging port or connector 26 connectable with the port or the connector 14 for charging the battery 12 when the device is not in use.

The memory unit, disk or chip 16 maybe pre-programmed with a set of questions, inquiries, directions or the like to be randomly or serially communicated to participants in a game. Alternatively, a programmable chip maybe used and programmed by a conventional computer to permit variations in the game to be played, or a disk may be removeably and replaceably mounted in the device 10 so that various pre-programmed disks may be used interchangeably. In appropriate circumstances, the memory may also contain the answers to the questions asked.

The game is played by two or more persons and the device 10 is passed or tossed from person to person and at an appropriate time or times, the device comes to rest with one of the participants. The memory 16 is then activated and a question or a direction is communicated to a recipient participant either aurally via the speaker 18 or visually via the display 20 or both aurally and visually. After the recipient participant responds to the question or direction, the device is again passed around until it comes to rest with a second recipient participant, whereupon the memory is again activated and a different question asked or a different direction given to the second recipient participant. The game continues in this manner until concluded. Scores may be kept if desired to determine a winner.

Representative applications include the following:

Interactive Party Ball

The interactive device 10 may, for example, take the form of the ball illustrated in FIG. 1 and be programmed to provide a party game targeted at young adults in a social or party situation. It is designed to be an interactive “ice breaker” that becomes a catalyst for conversation. It may be played with a mixed group of males and females of six or more.

The ball may be approximately five inches in diameter with a soft rubber-like exterior. Located on one side of the ball is visual display 20 where questions appear, similar to readouts on a typical cell phone. On the exterior of the ball there are parallel rows of lights that chase when the ball is activated.

To start the game a switch is activated that starts the chasing lights and simultaneously starts a timer. The ball is tossed among participating players in the same way as a “hot potato”. When the timer goes off, the ball makes a sound and the lights change to pulsate instead of chase. At this time, the person that is holding the ball must read and answer the random question that appears on the screen 20 and/or that is announced over the speaker 18. The questions may focus on dating, personal intimacies, moral and ethical dilemmas, etc. After the person answers the question, he or she then reactivates the ball and tosses it to start the process again.

The memory unit 16 may contain approximately 150 questions or enough questions for 15 or 20 people to play for several hours before starting to duplicate. For various topics or subjects the memory 16 may also contain the correct answers to the questions.

Interactive Educational Ball

An interactive educational ball operates on the same principle as the interactive party ball except that it is used for educational purposes, e.g., as an educational tool for school students.

The major design difference with the educational ball is that the teacher can download different questions into the ball based on the curriculum he or she is focusing on at the time. This gives the teacher creative flexibility.

The ball could be used as a tool to help children learn their timetables or as a competitive scavenger hunt game to prepare for an upcoming history or geography test. It can also be used as an icebreaker where students could acclimate themselves with each other at the beginning of a new school year or after vacation.

Name That Tune Ball

A name that tune ball would have sound chips that would play parts of songs ranging from the 50s to the current day. The players could pick categories by genre of music or a combination of all genres combined. The name that tune ball could be played by individuals or by teams. After each song is played, the individual player or team must identify the song and the performing artist. Players could choose different levels of play depending upon the difficulty of the category of music.

Movie Ball

A movie ball would be programmed with movie trivia questions and personal favorite questions designed to be conversation starters. The questions may, for example, be grouped into three separate eras; 20-40s, 50-70s and 80s through the current day.

The questions could cover every aspect of the movie industry. Mixed in with the various questions may be sound bites of famous lines that the players have to identify by actor and movie. The movie ball can be played by individuals or by teams. Players can choose different levels of play based upon the difficulty of the questions.

Morals and Ethics Ball

A Morals and Ethics ball would contain typical “would you” type questions. The questions center around everyday dilemmas. How an individual answers a question may reveal something about that person's character. This serves as an icebreaker or catalyst for conversation that would invariably follow each question.

Generic Sports Ball

A generic sports ball would take on the ball shape of the sport that it represents. The five major sport balls would include football, basketball, baseball, soccer and hockey. The hockey “ball” would comprise two perpendicular hockey pucks in the shape more or less of a ball.

The questions would be tailor made to each particular sport. This would target sports enthusiasts. The questions would cover a wide range of topics. Some examples of topics would be sports history, player and team historic moments, record holders, championship teams, famous quotes and hall of famers. The game could be played by individuals or by teams and at different levels of skill.

Individual Team Sports Ball

An individual sports ball would be similar to the generics sports ball except that each ball would focus on a particular team instead of an entire sport. The individual team ball would preferably come in team colors and play the team fight song where applicable. The individual team ball could cover college and pro sports teams for all major sports. The game could be played by individuals or by teams and at different levels of skill.

The objects and advantages of the invention have therefore been shown to be attained in a convenient, economical, practical and facile manner.

While certain presently preferred embodiments of the invention have been herein illustrated and described, it is to be appreciated that various changes, rearrangements and modifications may be made therein without departing from the scope of the invention as defined by the appended claims.

What is claimed is:

1. An interactive game for play by a number of persons comprising a device to be passed from person to person and that communicates to a recipient person a question and/or direction to be responded to by the recipient person.

2. An interactive game for play by a number of persons comprising a device to be passed from hand to hand, said device containing a speaker and/or visual display, a memory containing stored inquiries or directions coupled to, said speaker and/or display, and means for activating said memory and causing an inquiry or direction to be communicated via said speaker and/or display.

3. A game as set forth in claim 2 wherein said device comprises a ball to be tossed from one player to another and said means is activated by a recipient player.

4. A method of playing an interactive game among a plurality of players and employing the device of claim 2, comprising the steps of passing the device from a first player to a second player and activating the device to communicate an inquiry or direction to the recipient player and, following response by the recipient player to the inquiry or direction, passing the device from the second player to the first player or a third player and activating the device to communicate a different inquiry or direction to the recipient player, and repeating the foregoing steps.

5. A game as set forth in claim 2 wherein the memory contains inquiries or directions related to a subject category selected from sports, politics, religion, social issues, education, history, geography, mathematics, sciences, world affairs, morals, ethics and trivia.
